(19) United States
(12) Patent Application Publication
(10) Pub. No.: US 2005/0110467 A1
(43) Pub. Date: May 26, 2005

(54) Automotive jump starter with polarity detection and current routing circuitry

(75) Inventor: Lincoln Thomason, Boise, ID (US)

Correspondence Address: DYKAS, SHAVER & NIPPER, LLP, P.O. BOX 877, 802 WEST BANNOCK STREET, SUITE 405, BOISE, ID, 83701, US

(73) Assignee: Bon-Aire Industries, Inc., Boise, ID (US)

(21) Appl. No.: 10/980,752

(22) Filed: Nov. 3, 2004

Related U.S. Application Data
(60) Provisional application No. 60/517,214, filed on Nov. 3, 2003.

(51) Int. Cl. H02J 7/14

(52) U.S. Cl. 320/165

(57) ABSTRACT

A battery charger for use on lead acid and dry cell batteries having a polarity detection mechanism, automated current routing circuitry and excessive voltage protection. The battery charger of the present invention is configured to provide safe, spark free jump starting.

### PRIORITY

This application claims the priority date of the provisional application entitled A Goof Proof Automotive Jump-Starter With Polarity Detection and Current Routing Circuitry filed by Lincoln Thomason on Nov. 3, 2003 with application Ser. No. 60/517,214. The contents of which are herein incorporated by reference.

### BACKGROUND OF THE INVENTION

1. Field of the Invention

The present invention generally relates to mechanisms for charging automotive batteries, and more particularly to self-contained jump-starting apparatuses that contain a power source and a pair of cables that can be utilized to connect with and provide power to a disabled battery. The purpose of the connection with the disabled battery is in most instances to provide sufficient additional power so as to enable an automobile ignition system to operate.

2. Background Information

Lead acid and dry cell batteries are used in almost everything today, including motorcycles, ATVs, motor homes, automobiles, etc. One of the problems that exist with these batteries is that over time these batteries expend the power that is stored within them and as a result prove to be ineffective in providing sufficient power so as to enable a party to start a device such as an automobile. When such an instance occurs a party may “jump start” the battery by providing power from another source to the battery.

Providing a source of direct current to the battery that is to be charged typically charges batteries. Many different types of devices for providing this increased source of material to the battery exist. These include devices such as jumper cables. Jumper cables are typically comprised of two sets of cables. One set of cables is configured to connect the positive terminal of a first battery to the positive terminal of a second battery. The first battery is charged and the second battery is typically charge deficient. The second set of cables extends from the negative terminal of the first battery to an electrical ground such as the metal frame of the automobile or the engine block. When connected properly a circuit is completed and power is able to flow from the powered battery to the battery to be powered. In addition to jumper cables a variety of other types of devices also exist which utilize a similar type of configuration to allow a depleted battery to be re-energized.

These prior art devices, however, are also subject to a variety of deficiencies. One of the greatest deficiencies relates to the possibly dangerous consequences that may arise through improper use of such a device. When someone tries to charge a discharged battery, they must know which cable should be connected to which terminal on the battery and the order in which the cables should be connected. If the cables are connected in an improper order, the device may short circuit. This short-circuiting may cause extremely large current flows, arcing or sparking, dangerous over-heating of the cables and battery damage to the battery or supply, and possibly even explosion. When the discharged battery is within another larger device such as an automobile, truck, plane or other vehicle, damage to the electrical apparatus of that vehicle may also occur. This damage can occur not only to the disabled battery and the vehicle in which it is contained, but also to the powered battery and the vehicle in which it is contained.

The problems associated with properly connecting a battery is further exacerbated when the determination of the polarity of the batteries if difficult. Such a situation occurs when the markers indicating the polarity of the battery are obscured by dirt and oil, when the lighting conditions are poor (such as at night), or when the weather conditions are adverse (such as rain, snow or cold). These circumstances increase the probability that an error could be made in attempting to jump-start the disabled vehicle. As discussed previously, such an error could have disastrous consequences.

Therefore what is needed is a device that can be used simply and easily to provide power to a disabled battery. What is also needed is a device that enables a user to safely and accurately provide power to a disabled battery without regard to the alignment or orientation of the cables. What is also needed is a portable jump-starting device that can be utilized safely and easily in a variety of weather conditions by a person of limited skill or experience.

Some prior art attempts have been made to provide such a device, however, many of these device are subject to a variety of problems. One of these problems is that while the polarity of the device is accounted for, the rate at which power is transferred is not controlled and as a result arcing and sparking may result. Another problem that may occur in some such devices is that the devices, once connected, will continue to conduct electricity through the device until the powered battery is discharged. At this point if the powered battery is connected to another external battery, the routing device will be unable to detect the proper polarity. Also, if the jumper leads are connected to each other, the powered battery and the routing device could self-destruct. The present invention solves these problems.

Accordingly, it is an object of the present invention to provide a device that can be used to simply and easily provide power to a disabled battery. It is a further object of the invention to provide a device that enables a user to safely and accurately provide power to a disabled battery without regard to the alignment or orientation of the cables. It is a further object of the invention to provide a portable jump-starting device that can be utilized in a variety of weather conditions by a person of limited skill or experience. Another object of the invention is to provide a jump-starting device that appropriately routes electricity to the discharged battery and stops the flow of electricity through the device when a desired charge level has been reached.

Additional objects, advantages and novel features of the invention will be set forth in part in the description which follows and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

The present invention is a self-contained automobile jump starter made up of an attaching device configured to attach the jump starter to a vehicle to be jump started, a power providing device configured to provide a designated amount of electrical power through the attaching device, a polarity detection device that is configured to determine the polarity of a quantity of power through said jump starter, a regulator configured to regulate the quantity and polarity of power passing through said jump starter, a controller configured to receive inputs from the attaching device and to provide dispersal of power out of said device according to a designated protocol and according to a desired program, and a current leakage protection device configured to prevent loss of power from the power providing device when the jump starter is not in use.

In the preferred embodiment of the invention, the invention is a self-contained jump-starter having an internal battery that can be utilized to charge a discharged battery. The self-contained jump starter principally contains an internal charge source battery that is housed within a housing. A pair of cables is connected to portions of the battery. These cables have end portions, which contain clamps that are adapted to connect with the terminals of the battery that are to be recharged. In a preferred embodiment of the invention these clamps have a light connected thereto, which facilitates the use of the device by a user. The jump starter of the present invention further includes a first switch that activates the flow of electricity out of the device through the cables. In the preferred embodiment of the invention, a second switch is also included. This second switch activates the lights upon the clamps themselves. In the preferred embodiment a variety of other lights and switches are also utilized to designate various functions such as the charge status of the battery being charged as well as the level of the battery in the jump-starting unit.

The principal functional features of the present invention are enabled by a control circuit made up of at least the following items that are all interconnected by the appropriate electrical connection devices. The circuit of the present invention contains a bridge rectifier that is connected to a regulator and provides correct polarity to the regulator. The regulator is in turn connected to a current leakage protection circuit and to a microcontroller. The current leakage protection circuit is also connected to the internal battery. The current leakage protection circuit is configured to provide a ground for voltage reference and to prevent current from being drawn from the internal battery when the jump-starter unit is not in use. The current leakage protection device further has a switched capacity voltage converter and a polarity detection circuit. The polarity detection circuit is configured to provide either a high or a low input signal to a microcontroller.

The microcontroller has at least two analog to digital inputs and a signal-creating portion that is configured to direct a signal to the current leakage protection circuit. The microcontroller is configured to detect polarity and a minimum amount of voltage; to measure that amount of voltage and to determine whether the current leakage protection circuit should be shut off according to the measured amount of voltage and pre-selected criteria.

In the preferred embodiment, MOSFETs are utilized to provide various switching and signaling functions. In the preferred embodiment the device of the present invention is further comprised of a heat sensing and regulating device, an oscillator and a charge pump that is utilized to modify and direct the appropriate level of charge that is processed through the device.

The purpose of the foregoing Abstract is to enable the United States Patent and Trademark Office and the public generally, and especially the scientists, engineers, and practitioners in the art who are not familiar with patent or legal terms or phraseology, to determine quickly from a cursory inspection, the nature and essence of the technical disclosure of the application. The Abstract is neither intended to define the invention of the application, which is measured by the claims, nor is it intended to be limiting as to the scope of the invention in any way.

Still other objects and advantages of the present invention will become readily apparent to those skilled in this art from the following detailed description wherein I have shown and described only the preferred embodiment of the invention, simply by way of illustration of the best mode contemplated by carrying out my invention. As will be realized, the invention is capable of modification in various obvious respects all without departing from the invention. Accordingly, the drawings and description of the preferred embodiment are to be regarded as illustrative in nature, and not as restrictive in nature.

### BRIEF DESCRIPTION OF THE DRAWINGS

FIG. 1 is a perspective front plan view of a preferred first embodiment of the invention.

FIG. 2 is a schematic of a first preferred embodiment of the invention.

FIG. 3 is a schematic of a second preferred embodiment of the invention.

FIG. 4 is a schematic of a third preferred embodiment of the invention.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

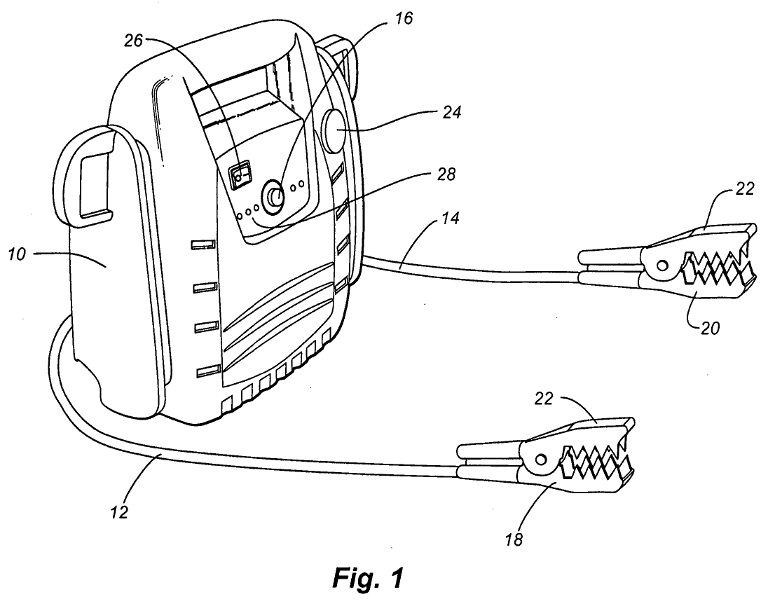

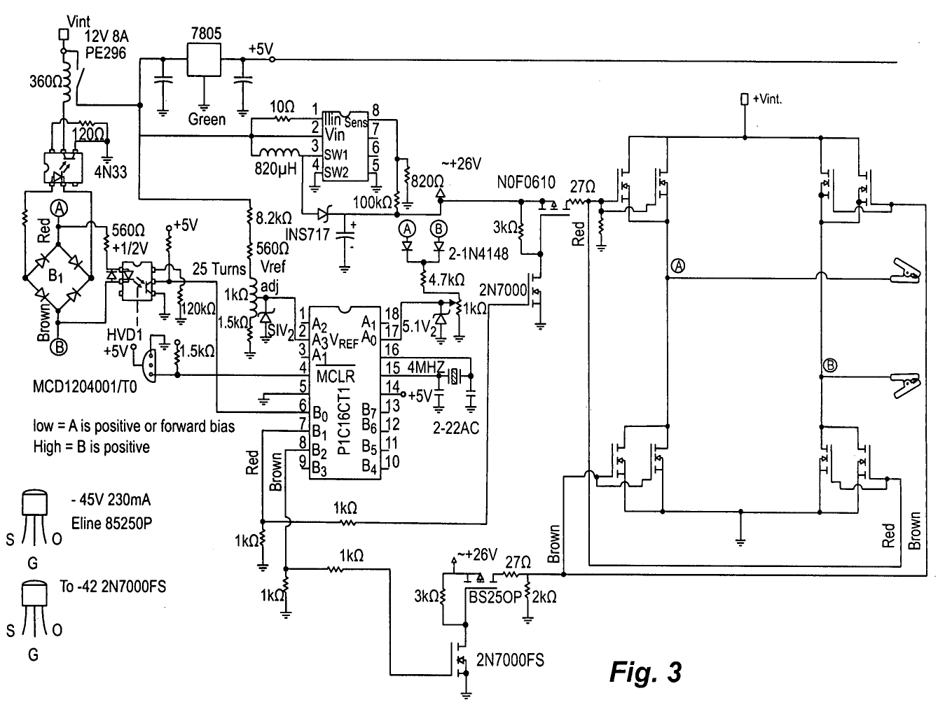

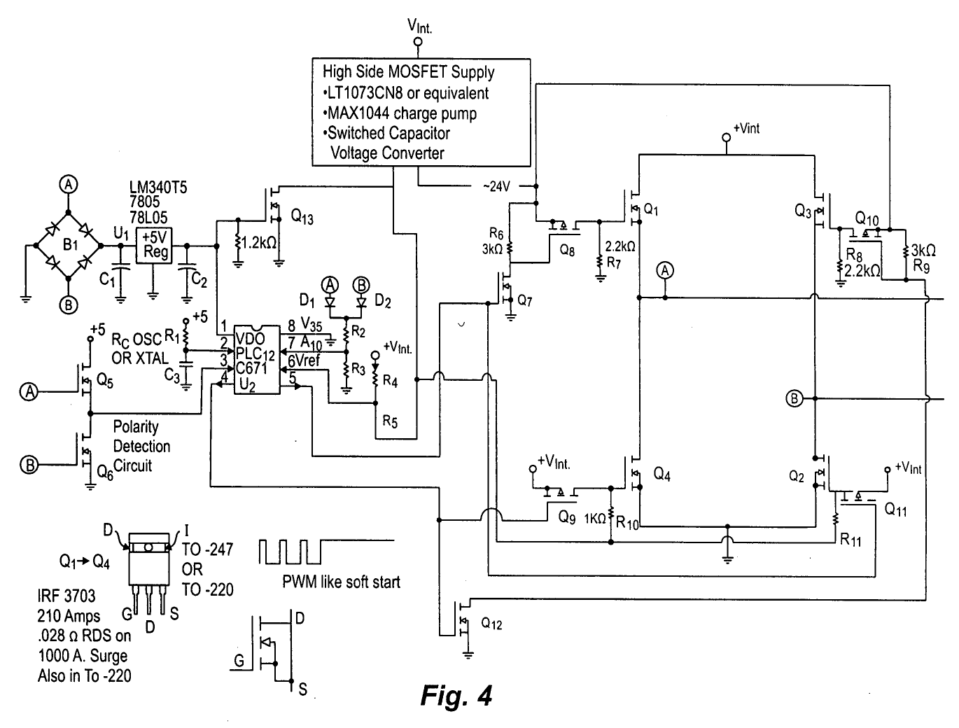

FIGS. 1-4 of the present invention show various features of the preferred embodiment of the invention. This invention includes various features and devices that allow the present invention to be utilized. In its simplest form, the present invention is a self-contained worry free jump starter that can be utilized by persons with little or no skill or experience in the field of automotive repair. The present invention allows a party to safely jump start a car with a battery by simply connecting the two cables on the device with the two terminals on the car battery activating the device and starting the car. The internal circuitry of the present invention detects and channels the flow of power from the storage battery to the battery to be charged. The present invention also prevents arcing or overheating of the cables or the battery itself and appropriately shuts off so as to prevent over-heating of the internal charge battery or damage to the battery that is to be charged. The result is a device that is easy, safe and effective to use.

Referring first to FIG. 1, a front plan view of the present invention is shown. The present invention is a jump starter that comprises a housing 10 having a pair of cables that extend therefrom. The housing 10 contains an internal battery, which is adapted to provide a sufficient amount of current to a battery that is to be jump-started. Preferably, the battery within the housing 10 is a rechargeable battery that is provided with appropriate accompanying circuitry so as to allow the battery to be recharged from a standard alternating current power supply. The battery is connected to a pair of cables 12,14 through a switching system which will be discussed further hereafter. The cables 12, 14 are connected to clamps 18, 20 which are each equipped with a light 22 that can be activated so as to facilitate a user in finding the location of the terminal upon which the clamps 18, 20 are to be attached. In the preferred embodiment, these lights 22 are LED lights, however it is to be distinctly understood that the invention is not limited thereto but may be variously embodied to meet the necessities of the user. In the preferred embodiment an accessory voltage access port 24 is also present so as to allow the battery of the device to be utilized to power a variety of other types of devices.

In the preferred embodiment of the invention the housing portion 10 of the device contains a switch 16 to send power through the cables of the device, a switch 26 to activate the lights that are attached to the ends of the clamps 18, 20 and several indicator lights 28 which signal such things as the status of the battery being charged, the battery from which the charge is being processed and the activation status of the cable clamps.

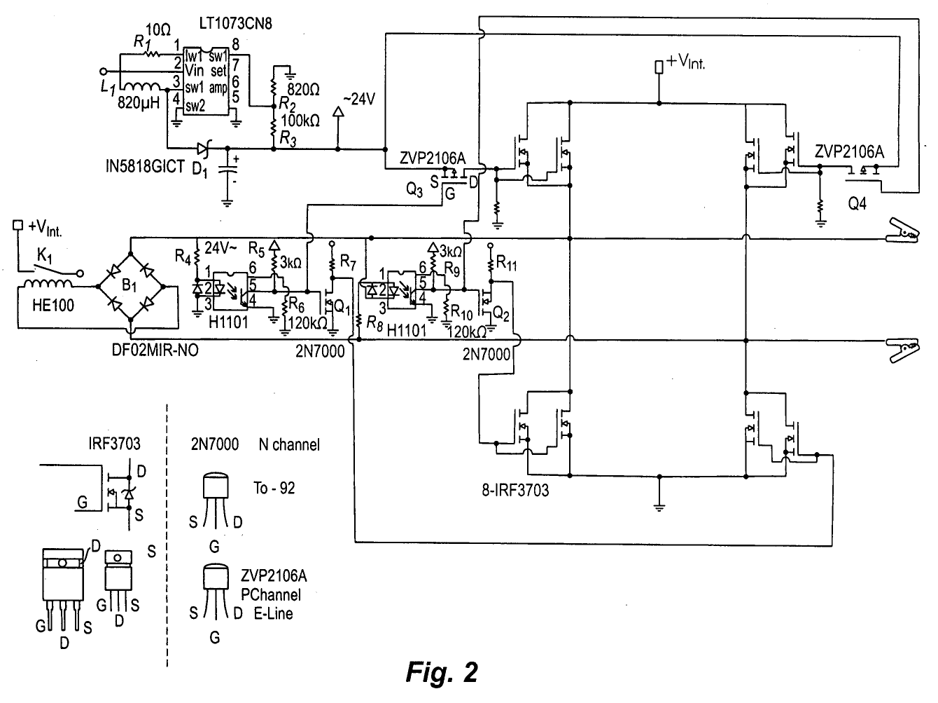

FIGS. 2, 3 and 4 show various routing schematics of the various internal component parts that are included in the present invention. In the preferred embodiment of the invention, the entire design is in CMOS in a single encapsulated package with four screw mounts like a solid state relay. This has proven to be a cost-effective design. The design of the present invention can also be implemented using an Application Specific Integrated Circuit (ASIC) or with discreet components. The encapsulated and ASIC implementations achieve the same goals as the discreet circuit does and therefore only one such embodiment is discussed.

The internal configuration of the present invention is compromised of a variety of circuits. These circuits include a rectifier and regulator, a current leakage protection circuit, a polarity detection circuit, a microcontroller, an oscillator and a metal oxide field effect transistor (MOSFET). In the preferred embodiment, a bridge rectifier provides the correct polarity to a five-volt regulator. Other regulators, such as 3.3 volt or 2.5 volt, may also be used.

A current leakage prevention circuit is needed to prevent current from being drawn from the +Vint (internal battery voltage of the jump-start unit) when the unit is not in use. This circuit provides a ground for voltage reference. The MOSFET (discussed below) needs to be selected on the basis of having inherently low leakage current (in the nA range). The drain current will also need to be considered in the event that the N channel MOSFETs are used for Q1 and Q2 because Q13 will also provide ground to the high side charge pump supply.

The polarity detection circuit provides a low or high input to the microcontroller. A logic high will cause the microcontroller to bias Q1 and Q2. A logic low will cause the microcontroller to bias Q3 and Q4. In order to cause a short circuit, both Q5 and Q6 would have to be biased. To do so both “A” and “B” would have to be positive. The only way that the +5 volts can be present is if one of the inputs is low and the other is high. So, there is no chance that both “A” and “B” can be positive at the same time.

The preferred microcontroller is manufactured by Microchip and is well known in the art. However, other microcontrollers can be used in the implementation of this circuit as long as it has at least two analog to digital (A/D) inputs. The MOSFET's “H” bridge can be driven with the pulse width modulation (PWM) like signal. By using the PWM, there will be a reduction in the surge current and will prevent sparking by gradually increasing the output voltage. This feature will also allow less expensive MOSFETs to be used.

There are two main conditions that must be met before the output is energized by the microcontroller. The first is that the polarity must be detected and a predetermined minimum voltage must be present. The second is that the voltage must be measured to determine if the voltage is greater or less than the +Vint. If “A” or “B” is the same voltage or higher than the +Vint, then the MOSFETs are shut off. This finding would result when the jumper cables are disconnected from the battery being charged or if there is a higher potential than +Vint. In either case, the H bridge should be disconnected from +Vint. If the voltage is less than +Vint, then the H bridge should remain activated.

The entire energy of the jump starter battery can be delivered to a vehicle to be started without exceeding the ratings of the MOSFETs and by utilizing the programmed microcontroller to manage the jump-start time. The microcontroller can be programmed to gradually increase the output current using PWM drive to the MOSFET H bridge at the desired current level.

During the initial time, the microcontroller would drive the PWM duty cycle up to the maximum safe current of the MOSFETs. This will allow a transfer of energy to the vehicle's battery. The transfer of energy allows the vehicle's battery to be built up so that when the driver tries to start the vehicle, the current will flow from the battery of the vehicle as well as the battery on the jump starter later reducing the current requirement from the jump start.

The present invention limits the amount of power that is allowed to flow out of the internal battery in the jump-start device. This prevents a battery from continuing to conduct electricity until the internal battery is discharged and also prevents the jump starter from self-destructing in the event that the jumper cables are connected together. The present invention utilizes a microcontroller to measure and detect this condition, and in the event that the condition is noted, the condition can be corrected by turning off the MOSFET H bridge bias.

The present invention also includes an oscillator. The exact type of oscillator is not specifically required. An RC oscillator, crystal or resonator can be used.

The algorithm that is used by the microcontroller for charging lead acid and dry cell batteries makes preprogrammed decisions based on battery charge curves. In the preferred embodiment of the invention, the analog reference voltage (V Ref.) is converted to a digital reference voltage by the microcontroller and compared with either the “A” or “B” points of the bridge, depending on the output polarity. The output polarity is also converted to digital reference signal through use of the microcontroller. Without the ability to measure the internal battery and compare it to the external (dead) battery, these features cannot be obtained. Also, preventing the self-bias condition is very important. Self-bias occurs when the clamps are disconnected from the external battery and the H bridge remains in conduction providing current to the regulator. This condition can be detected by measuring the difference between the +Vint and the H bridge output voltage. If they are the same, then the H bridge is not conducting current and thus can be shut off. This mimics the voltage that occurs when an automobile is started, thus the microcontroller will remove the bias from the H bridge.

In order to detect polarity, there must be some minimum voltage. This minimum voltage requirement (V bridge rectifier +5V regulator) can be reduced with minimal circuit change to 1V or less, but not eliminated. The reason that it cannot be eliminated is because the circuit design goal is to detect polarity and then route charging current accordingly. The schematic shows a microcontroller operating at 5V.

Metal oxide field effect transistors (MOSFETs) are used in the preferred embodiment. The preferred MOSFET is the IRF3703 N-channel made by International Rectifier. However, other MOSFETs can also be used. The preferred MOSFETs also have an IDM pulsed drain current of approximately 1,000 amps (as rated by the manufacturer), which is a repetitive rating of pulse width limited by maximum junction temperature, which must be monitored to prevent exceeding the current rated by the manufacturer.

The high side MOSFET supply can be eliminated if P channel devices are used or a charge pump switched capacitor voltage converter is present. The gate circuits of the MOSFET pairs Q5, Q6 and Q9, Q10 must be driven by a high side supply at least 10V higher than the voltage of the internal battery. The gate drive requirements for a power MOSFET utilized as a high side switch with the drain connected to the high voltage rail, driven in full enhancement mode (i.e. lowest voltage drop across its terminals), requires a couple of things. First, the gate voltage must be 10-15V higher than the drain voltage. Being a high side switch, such gate voltage would have to be higher than the rail voltage. Second, the gate voltage must be controlled from the logic, which is normally referenced to the ground. Thus, the control signals have to be level shifted to the source terminal of the high side power MOSFET device. The power absorbed by the high side gate drive circuitry is minimal and does not significantly affect the overall efficiency. The most cost effective way to do this is to use a change pump switched capacitor circuit, which will provide a high voltage, low current bias for the high side MOSFETs.

The LT1073CN8 IC is a micro power DC to DC converter with adjustable output that provides the bias voltage necessary to drive the high side MOSFETs. The voltage divider made from R2 and R3 set the output voltage in this circuit to about 26V, which is more than adequate considering the gate voltage only needs to be 10V higher than the drain voltage.

The voltage and current to the MOSFET H bridge is supplied by the internal battery. The current for the PWM drive and MOSFET bias signals are supplied by the internal battery according to the schematic. Based on the schematic, the only gate bias that is dependent of the external battery is that of Q5 and Q6, the polarity detection circuit. All of the other MOSFET Vs is supplied by the internal battery. The voltage of the external stalled (defective) battery need only be high enough to forward bias to the bridge rectifier and the chosen regulator.

The MOSFET H bridge can be made with eight MOSFETs by connecting 2 MOSFETs in parallel in each branch of the H bridge. In the preferred embodiment of the invention the device may be constructed with only four MOSFETs.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

1. A circuit configured for use in an automobile jump-starter having an internal battery comprising:
a bridge rectifier configured to provide correct polarity to a regulator, said bridge rectifier connected to a regulator;
said regulator connected to a current leakage protection circuit and to a microcontroller;
said current leakage protection circuit connected to said internal battery, said current leakage protection circuit configured to provide a ground for voltage reference and to prevent current from being drawn from said internal battery when said jump-starter unit is not in use, said current leakage protection device further comprising a switched capacity voltage converter; and
a polarity detection circuit, said polarity detection circuit configured to provide either a high or a low input to a microcontroller;
said microcontroller having at least two analog to digital inputs and a signal creating portion configured to direct a signal to said current leakage protection circuit, said microcontroller configured to detect polarity and a minimum amount of voltage; to measure amount of voltage, and to determine whether said current leakage protection circuit should be shut off according to said measured amount of voltage and a pre-selected criteria.

2. The circuit of claim 1 wherein said current leakage protection circuit contains at least one MOSFET device.

3. The circuit of claim 1 wherein said polarity detection circuit device contains at least one MOSFET.

4. The circuit of claim 1 further comprising a heat sensing and regulating device.

5. The circuit of claim 1 further comprising an oscillator.

6. The circuit of claim 1 further comprising a charge pump.

7. A self contained automobile jump starter comprising:
an attaching device configured to attach said jump starter to a vehicle to be jump started;
a power providing device configured to provide a designated amount of electrical power through said attaching device;
a polarity detection device configured to determine the polarity of a quantity of power through said jump starter;
a regulator configured to regulate the polarity of power through said jump starter;
a controller configured to receive inputs from said attaching device and to provide dispersal of power out of said device according to a designated protocol and according to a desired program;
a current leakage protection device configured to prevent loss of power from said power providing device when said jump starter is not in use.
